(19) United States
(12) Patent Application Publication
(10) Pub. No.: US 2020/0147712 A1
(43) Pub. Date: May 14, 2020

(54) SYSTEMS AND METHODS TO DESIGN PART WELD PROCESSES

(71) Applicant: Illinois Tool Works Inc., Glenview, IL (US)

(72) Inventor: Adam Pliska, Neenah, WI (US)

(21) Appl. No.: 16/670,596

(22) Filed: Oct. 31, 2019

Related U.S. Application Data
(60) Provisional application No. 62/755,033, filed on Nov. 2, 2018.

(51) Int. Cl. B23K 9/095; B23K 31/12; G05B 19/042

(52) U.S. Cl. CPC B23K 9/0953; G05B 19/0426; B23K 9/0956; B23K 31/125

(57) ABSTRACT

Systems and methods to design part weld processes are disclosed. An example system to generate weld instructions for display to a weld operator during a welding sequence includes: a processor and machine readable instructions which cause the processor to: provide an interface to define a weld program including a sequence of weld instructions for display to a weld operator during a weld sequence, the weld program including a plurality of properties; determine, for each of the weld instructions, respective values for one or more properties that are defined via the interface; and generate the weld program including the sequence of weld instructions by, for each of the weld instructions in the sequence of weld instructions: determining default values for the properties that have not been defined for the weld instruction,; and generating a visual representation of the weld instruction using the defined values and using the determined default values.

### RELATED APPLICATIONS

This patent claims priority to U.S. Provisional Patent Application Ser. No. 62/755,033, filed Nov. 2, 2018, entitled “ SYSTEMS AND METHODS TO DESIGN PART WELD PROCESSES.” The entirety of U.S. Provisional Patent Application Ser. No. 62/755,033 is incorporated herein by reference.

### FIELD OF THE DISCLOSURE

This disclosure relates generally to welding, and more particularly, to systems and methods to design part weld processes.

### BACKGROUND

Many high volume, complex welded assemblies are produced using manual or semi-automated production welders. The repetitive nature of these welding operations and the high production rates that are required eventually lead to welder fatigue. Therefore, missing or defective welds on these welded assemblies is a quality assurance problem.

To identify defective welds, sensors that measure current, wire feed, voltage, and gas flow are used to enable the quality of a weld to be determined. The information produced by the sensors allows defective welds or welds of a quality less than a pre-determined quality to be identified.

### SUMMARY

Systems and methods to design part weld processes are disclosed, substantially as illustrated by and described in connection with at least one of the figures, as set forth more completely in the claims.

### BRIEF DESCRIPTION OF THE DRAWINGS

These and other features, aspects, and advantages of the present disclosure will become better understood when the following detailed description is read with reference to the accompanying drawings in which like characters represent like parts throughout the drawings, wherein:

FIG. 1 is a schematic diagram of an example system to provide arc-weld monitoring with part-tracking system, in accordance with aspects of this disclosure.

FIG. 2 is a block diagram of an example computing system that may be used to implement the computing device or the central computing system of FIG. 1.

FIG. 3 is a block diagram of an example computing system to design a workflow or part weld process, in accordance with aspects of this disclosure.

FIG. 4 illustrates an example design interface that may be used to implement the design interface of FIG. 3.

FIG. 5 illustrates an example part weld process properties interface that may be used to implement the design interface to configure default values at an example configuration level.

FIG. 6 illustrates an example interface including example weld instructions of a weld program as presented on the example computing device 10 of FIG. 1, in which properties of the weld instructions are controlled based on default values for the weld program.

FIG. 7 is a flowchart representative of example machine readable instructions which may be executed to generate weld instructions and/or other aspects of a part weld process.

FIG. 8 is a flowchart representative of example machine readable instructions which may be executed to determine values for properties of a weld instruction.

FIG. 9 is a flowchart representative of example machine readable instructions which may be executed to present weld instructions to an operator based on a weld program.

FIG. 10 illustrates example weld instruction data and/or metadata that may be used to define properties of weld instructions for creation and/or presentation of weld programs.

The figures are not necessarily to scale. Wherever appropriate, similar or identical reference numerals are used to refer to similar or identical components.

### DETAILED DESCRIPTION

Disclosed systems and methods allows users of a weld monitoring application to configure properties, or settings, that control how the application responds in specific situations. One example of a setting is the color of a visual weld ‘dot’ drawn on a slide canvas. This weld can be configured to be presented to a weld operator in a welding cell as a specific color depending on the state of the weld. During the setup of the weld program, the user can select the desired color for a weld when the weld has a given state. In this way, the user can create a default mapping between colors and welds, and during the welding operation the weld will be drawn in that color on the slide canvas when the weld is in a corresponding state. Disclosed systems and methods permit the user to override this color mapping at various hierarchical levels defining the structure of the application. At each level, the user can set what the desired color map, and those settings will be applied down the set of hierarchical levels to any level where a property has not been overridden.

The ability for the user to set up default values for properties at a root level and to override those settings at other levels saves the user time to create and/or modify weld programs, because the user does not need to specify the properties and/or other configuration elements each time the property is invoked. Instead, the user can configure the desired properties in fewer locations. When changes to a weld program are made, the user can make those changes in significantly fewer locations. As an illustrative example, 100 parts with an average of 10 slides per part and an average of 5 welds per slide have 5,000 individual locations in the interface 400 where properties such as weld colors are to be configured. If setting all of the weld colors requires 25 separate interface actions (e.g., mouse clicks, keystrokes, touchscreen touches), the 100 parts would require 125,000 individual interface actions to change the color scheme for their environment.

Disclosed example systems to generate weld instructions for display to a weld operator during a welding sequence include: a processor; and a machine readable storage device comprising machine readable instructions which, when executed by the processor, cause the processor to: provide an interface to define a weld program comprising a sequence of weld instructions for display to a weld operator during a weld sequence, the weld program comprising a plurality of properties; determine, for each of the weld instructions in the sequence of weld instructions, respective values for one or more of the properties that are defined via the interface; and generate the weld program comprising the sequence of weld instructions by, for each of the weld instructions in the sequence of weld instructions: determining, for one or more of the properties that have not been defined for the weld instruction, default values for the properties; and generating a visual representation of the weld instruction using the values that are defined for the weld instruction and using the determined default values.

In some example systems, the machine readable instructions cause the processor to, for each of the weld instructions in the sequence of weld instructions: determine one or more hierarchical levels corresponding to the default values; and determine the default values based on values set at the corresponding hierarchical levels. In some examples, the machine readable instructions cause the processor to: identify a change in at least one of the default values used by the sequence of weld instructions; and update the weld program based on the change.

In some example systems, the hierarchical levels include at least one of: a root level, the processor configured to use a value for one of the properties defined at the root value as a default value for any slide; a part level defined for a part, the processor configured to use a value for one of the properties defined at the part level as a default value for any slide associated with the part; a slide master level, the processor configured to use a value for one of the properties defined at the slide master level as a default value for any slide associated with the slide master; a slide level, the processor configured to use a value for one of the properties defined at the slide level as a default value for any weld instructions associated with the slide; or a weld instruction level, the processor configured to use a value for one of the properties defined at the weld instruction level as a default value for any weld associated with the weld instruction.

In some examples, the machine readable instructions cause the processor to: identify a change in one of the properties from the corresponding default value to a defined value; and update the weld program based on the change. In some examples, the one or more properties include at least one of: an operator shift time, a welding parameter threshold, a welding productivity goal, an operator authorization, an operator interface configuration, or a workflow event configuration. In some example systems, the one or more properties include a pointer to a configuration file representative of a plurality of the one or more properties. In some examples, the one or more properties include at least one of: an object color, a text color, a background color, a text typeface, a text font, or a background image.

In some example systems, the weld program defines an event and a response to the event, wherein the processor is configured to generate the weld program by: determining, for one or more of the properties for the event, default values for the properties; and in response to an event trigger, performing the event based on the default values for the one or more properties of the event.

Some example systems, for monitoring welding of components of a workpiece with multiple arc welds in a fixture include a computing device storing a weld program defining weld instructions for performing the multiple arc welds, the computing device configured to: parse the weld program to identify weld instructions associated with a sequence of welds for the workpiece; determine, for a first one of the weld instructions, whether a first property of the first one of the weld instructions has a defined value; in response to determining that the first property does not have a defined value, determine a default value for the first property; and provide the first one of the weld instructions to a weld operator based on the default value of the first property.

In some examples, the computing device is configured to: determine, for a second one of the weld instructions, whether a second property of the second one of the weld instructions has a defined value; and in response to determining that the second property has a defined value, provide the second one of the weld instructions to a weld operator based on the defined value of the second property. In some examples, the computing device is configured to: monitor an interface with the data collection device to detect an event defined in the weld program based on a state of the interface; and in response to detecting the event, taking one or more actions defined in the weld program. Some example systems further include one or more weld sensors configured to collect data associated with the multiple arc welds, in which the computing device is configured to determine statuses of the multiple arc welds based on the data.

Some disclosed example systems for monitoring welding of components of a workpiece with multiple arc welds in a fixture include: one or more weld sensors configured to collect data associated with the multiple arc welds; a data collection device configured to monitor the one or more weld sensors; and a computing device storing a weld program, the computing device configured to: provide weld instructions defined in the weld program and associated with a sequence of welds for the workpiece; monitor an interface with the data collection device to detect an event defined in the weld program based on a state of the interface; and in response to detecting the event, taking one or more actions defined in the weld program.

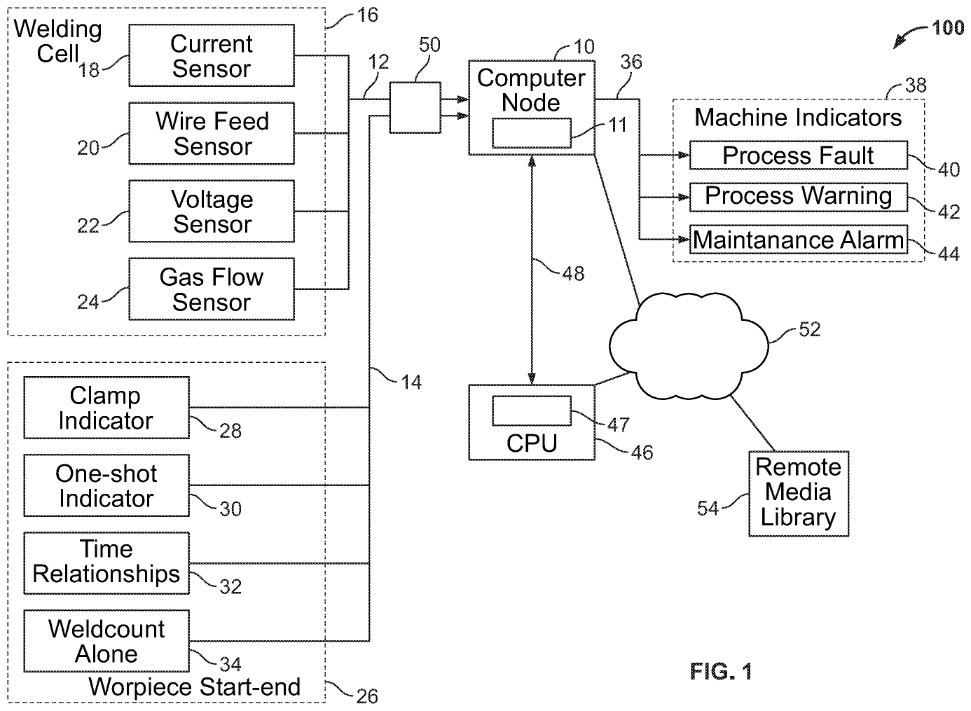

FIG. 1 is a block diagram that illustrates an example arc-weld monitoring with part-tracking system 100. The system 100 operates a network including one or more computing devices operably connected by a network to one or more central computing systems 46. Each computing device 10 receives sensor inputs 12 and digital inputs 14 from welding cell 16 in which one or more welds is being applied to a workpiece. Each computing device 10 can display real-time information concerning a weld on text display screen 11. Example sensor inputs 12 include weld quality information provided by a current sensor 18, a wire feed sensor 20, a voltage sensor 22, and/or a gas flow sensor 24. Example digital inputs 14 include information related to starts and/or ends of a workpiece (e.g., workpiece start-end 26), which may include a clamp indicator 28 and/or a one-shot indicator 30. Additionally or alternatively, the workpiece start-end 26 may be programmed into the computing device 10 and include time relationships 32 and/or weld count 34 alone.

The example computing device 10 processes sensor input 12 and/or digital input 14, and generates one or more digital outputs 36. Example digital outputs 36 include machine indicators 38 such as a process fault 40, a process warning 42, and/or maintenance alarms 44. The digital output 36, which indicates the status of the weld just completed and the requirements for the next weld to be made, can be provided to the operator (e.g., welder) who is welding the workpiece and/or to a system operator for monitoring an automated welding operation. In some examples, when a weld is determined to be defective, the digital output 36 causes the welding operation to stop, which allows the defective weld to be repaired or the workpiece with the defective weld to be discarded. The example computing device 10 tracks sensor input 12 and digital input 14 for each weld of a plurality of welds in the workpiece (e.g., a part) and quality determination(s) made for each weld of the part.

The central computing system 46 includes a display 47 and is operatively connected 48 to the computing device(s) 10. The central computing system 46 operates the computer program that is used to configure the computing device(s) 10 for particular welding operation(s) and/or to receive the information from the computing device 10 for data logging, further weld analysis, statistical process control (SPC), and/or part-tracking. The computing system 46 can be connected to a plurality of computer nodes for monitoring welding operations in a plurality of welding cells by means of a computer network (not shown). The example computing system 46 performs part-tracking by receiving and storing information related to the welding operations from the various computing devices. After performance of welds and capture of weld information by the computing device(s) 10, the example computing system 46 may receive the weld information from the computing device(s) 10 and/or display the weld information on the display 47.

As described in more detail below, the example central computing system 46 and/or the computing device(s) 10 may include one or more computers, servers, workstations, and/or any other type of computing system, and may enable administrators, weld engineers, and/or other personnel to design the weld instructions that are to be displayed in or near the weld cell 16 (e.g., via the computing device 10) and performed by the weld operators. Disclosed examples enable easier part weld process design via user interfaces, including dragging and dropping weld components or instructions from a library onto a slide to create weld instructions, defining events and/or weld instructions in response to events, enforcing rules during part weld process design, and/or defining slide masters for use in creating multiple slides.

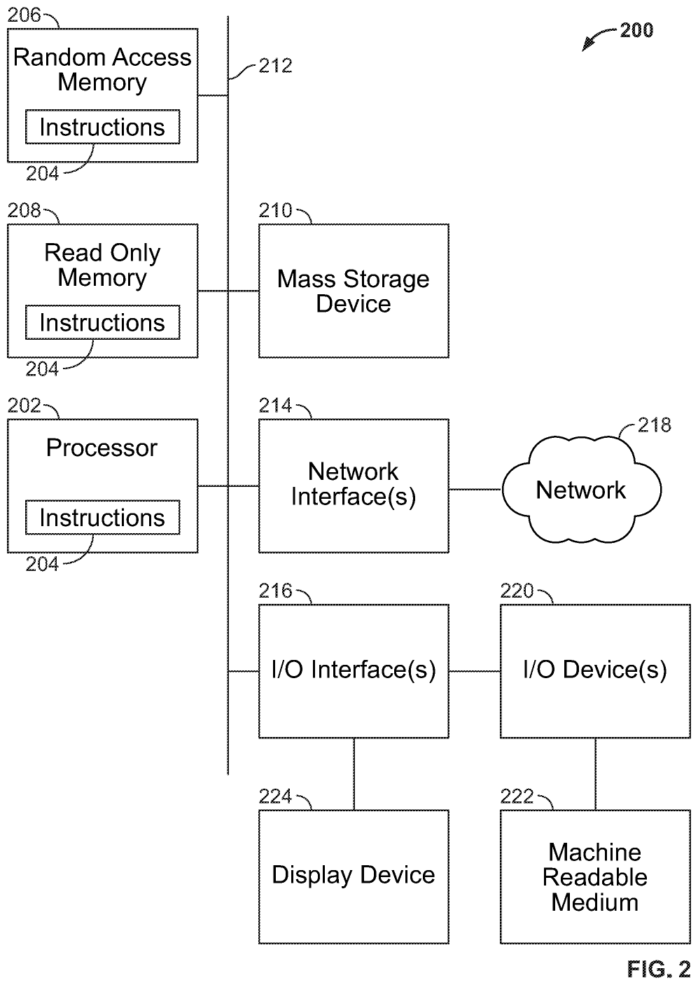

FIG. 2 is a block diagram of an example computing system 200 that may be used to implement the computing device 10 or the central computing system 46 of FIG. 1. The example computing system 200 may be implemented using a personal computer, a server, a smartphone, a laptop computer, a workstation, a tablet computer, and/or any other type of computing device.

The example computing system 200 of FIG. 2 includes a processor 202. The example processor 202 may be any general purpose central processing unit (CPU) from any manufacturer. In some other examples, the processor 202 may include one or more specialized processing units, such as RISC processors with an ARM core, graphic processing units, digital signal processors, and/or system-on-chips (SoC). The processor 202 executes machine readable instructions 204 that may be stored locally at the processor (e.g., in an included cache or SoC), in a random access memory 206 (or other volatile memory), in a read only memory 208 (or other non-volatile memory such as FLASH memory), and/or in a mass storage device 210. The example mass storage device 210 may be a hard drive, a solid state storage drive, a hybrid drive, a RAID array, and/or any other mass data storage device.

A bus 212 enables communications between the processor 202, the RAM 206, the ROM 208, the mass storage device 210, a network interface 214, and/or an input/output interface 216.

The example network interface 214 includes hardware, firmware, and/or software to connect the computing system 200 to a communications network 218 such as the Internet. For example, the network interface 214 may include IEEE 202.X-compliant wireless and/or wired communications hardware for transmitting and/or receiving communications.

The example I/O interface 216 of FIG. 2 includes hardware, firmware, and/or software to connect one or more input/output devices 220 to the processor 202 for providing input to the processor 202 and/or providing output from the processor 202. For example, the I/O interface 216 may include a graphics processing unit for interfacing with a display device, a universal serial bus port for interfacing with one or more USB-compliant devices, a FireWire, a field bus, and/or any other type of interface. The example weight indicator 116 includes a display device 224 (e.g., an LCD screen) coupled to the I/O interface 216. Other example I/O device(s) 220 may include a keyboard, a keypad, a mouse, a trackball, a pointing device, a microphone, an audio speaker, an optical media drive, a multi-touch touch screen, a gesture recognition interface, a magnetic media drive, and/or any other type of input and/or output device.

The example computing system 200 may access a non-transitory machine readable medium 222 via the I/O interface 216 and/or the I/O device(s) 220. Examples of the machine readable medium 222 of FIG. 2 include optical discs (e.g., compact discs (CDs), digital versatile/video discs (DVDs), Blu-ray discs, etc.), magnetic media (e.g., floppy disks), portable storage media (e.g., portable flash drives, secure digital (SD) cards, etc.), and/or any other type of removable and/or installed machine readable media.

As used herein, the term “part” refers a logical grouping of steps necessary to complete a unit of work. The logical grouping of steps defining a part may relate to a manufactured part (i.e., assembly, component, product, etc.) on a manufacturing floor.

As used herein, the term “slide” refers to a view. A slide may contain multiple welds defined within the view.

As used herein, the term “slide master” refers to a slide template, from which one or more slides may be created using properties defined for the slide master.

As used herein, the term “weld instruction” refers to a welding-related operation, which may involve actually welding (e.g., arc-on activity), preparing to weld, cleaning up after welding, fetching components, shift-related activity, and/or any other operations. A slide may contain multiple welding-related operations or weld instructions, and a weld represented by the weld instruction may be tracked and distinguished from other welds by a weld monitoring system using sensors. A weld instruction may be duplicated across multiple slides or parts.

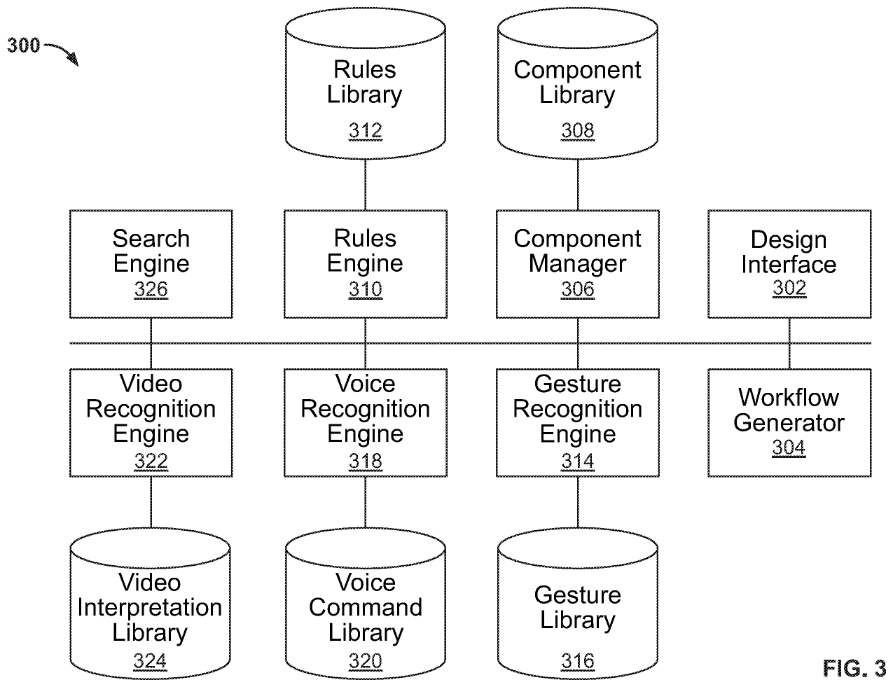

FIG. 3 is a block diagram of an example computing system 300 to design a workflow or part weld process. The example computing system 300 may be implemented as any combination of hardware, firmware, and/or software, such as software components executed by the computing system 200.

The example computing system 300 includes a design interface 302 to receive input and provide output for design of a part weld process, including workflow and/or slides. The design interface 302 may be implemented using the display device 224 and one or more of the I/O devices 220 of FIG. 2. In some examples, the part weld process is at least partially constructed or defined using one or more slides. As used herein, a “slide” refers to a single visual screen that can be created and/or edited by a designer (e.g., an administrator, a shop foreman, an engineer, etc.) via the design interface 302 to show one or more of the steps in a larger unit of work. The process to complete a part may involve multiple slides shown to a weld operator in a sequence.

The part weld processes may further include workflows. When executed (e.g., at the computing device 10), workflows include events that may trigger responsive weld instructions within the workflow based on inputs to the computing device 10, slides that are shown to the weld operator to provide weld instructions, weld instructions that may block further execution until appropriate interaction occurs by the weld operator, real-time weld quality monitoring and feedback during the workflow, and/or any other weld instructions. A workflow generator 304 creates workflows based on slides, events, instructions, and/or other inputs received via the design interface 302. During the runtime welding process, the weld operator is presented with the diagram that has been designed on the slide. The weld operator uses the diagram and associated weld instructions to understand and perform the steps necessary to complete the part or other unit of work defined in the workflow.

Using the example computing device 10 and/or the computing system 46 of FIG. 1, a designer can design visual slides, which may visually represent or resemble a schematic, toe used which a weld operator uses during production to understand the steps necessary to finish the part or other unit of work. A component manager 306 of the computing system 300 manages components stored in a component library 308. Example components may include elements (e.g., shapes), welds, annotations, images, media (e.g., audio, video), and/or areas. However, any other component type may be used.

Components may be created, selected, added to slides, modified, deleted from slides, and/or otherwise manipulated by a designer or maintenance personnel of the computing system 300 via the design interface 302, and changes are stored by the example component manager 306 in the component library 308.

In some examples, visual elements may be selected and positioned onto a slide using an input device (e.g., a computer mouse, a touchscreen, etc.). Those elements are dragged from a pool of elements, welds, annotations, images, and areas, and dropped onto a working canvas that represents the slide. Disclosed examples enable part weld process design using unconventional design tools, such as a tablet computer or other drawing tablet.

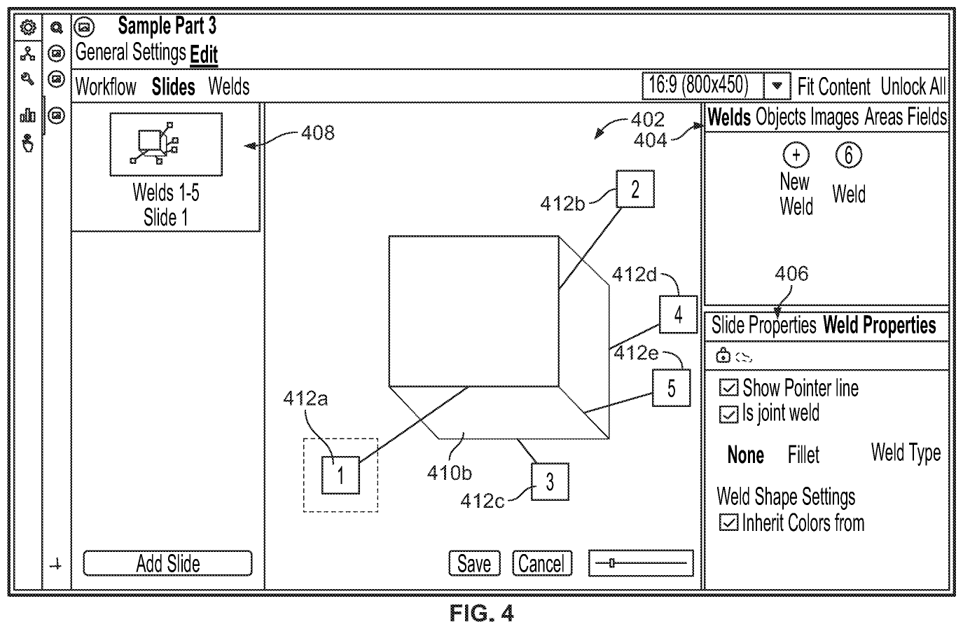

FIG. 4 illustrates an example design interface 400 that may be used to implement the design interface 302 of FIG. 3. The example design interface 400 enables a user to define a weld program including a sequence of weld instructions for display to a weld operator during a weld sequence, and includes a slide canvas 402, a component selector 404, a component properties manager 406, and a slide menu 408. The slide canvas 402 is a visual representation of the weld instructions that are shown to the operator via the computing device 10 during operation. Components such as part elements 410a, 410b and weld indicators 412a, 412b, 412c, 412d, 412e may be dragged from the component selector 404 to a desired position on the slide canvas 402. The component selector 404 enables a designer to select any component available from the component library 308 for inclusion in the slide canvas 402. The example component manager 306 also track deletion of previous components from the slide canvas 402 and may make resulting changes to other components. For example, if a first weld in a weld order (e.g., the weld indicator 412a) is removed from the slide canvas 402, the example component manager 306 adjusts the weld numbers of the remaining slide indicators 412b-412e and makes another weld indicator available in the component selector 404.

The weld program includes instructions to weld, represented by the indicators 412a-412e, instructions to clamp and/or unclamp a part, instructions to inspect a part, instructions to repeat or repair a weld, instructions to observe media such as an image, video, and/or audio, instructions to begin or end a break period, instructions to begin or end a shift period, and/or any other instructions. The instructions 412a-412e have properties, such as visual properties, behavioral properties, event-based properties, status-based properties, and/or other property types, that may provide information and/or visual cues to an operator during performance of the weld instructions 412a-412e. Properties may be specified and/or determined for settings such as shifts, thresholds, goals, user permissions, device settings, weld programs, work instructions (e.g., weld instructions), workflow events, groups of downloadable settings from a library. Different configurations of properties may depend on other variables, such as a first weld cell using a first color scheme because the first weld cell is located in a darker room compared to a second weld cell, which may use a different color scheme to be seen clearly. In another example, a first font size may be set based on the identity of a first operator (e.g., to improve readability for the first operator) while a second font size is set based on the identity of a second operator (e.g., to fit more information on the same screen).

The component properties manager 406 enables a designer to specify certain properties of the slide and/or of the component(s). The specified properties are stored by the component manager 306 in the component library 308. Example properties include definition of colors, and inheritance of one or more properties from other slides or components. The properties of weld instructions may be specified for each individual weld instruction and/or inherited from one of a plurality of levels: a weld instruction level, which defines default properties for any weld or other sub-instruction associated with the weld instruction; a slide level, which defines default values for any weld instructions associated with the slide, and corresponding sub-instructions in the weld instructions; a slide master level, which defines default values for any slide associated with the slide master, and any weld instructions and/or sub-instructions defined on those slides; a part level, which defines default values for any slide associated with a part, and any weld instructions and/or sub-instructions defined on those slides; a root level, which defines default values for one of the visual properties defined at the root value as a default value for any slide.

The slide menu 408 enables creation and/or deletion of slides from a part weld process, and/or selection of particular slides of a part weld process for modification.

When the instructions have been specified for one or more slides, the interface 400 generates a weld program to display the weld instructions (e.g., via the 412a-412e). While generating the weld program, the workflow generator 304 determines values for the instructions 412a-412e based on values that are specified for the instructions 412a-412e and, if values are not specified, default values at one or more levels. For example, the example workflow generator 304 determines the hierarchical levels corresponding to the default values (e.g., the property values not specified for properties), and determines the default values set at the corresponding hierarchical levels. Based on the values for the properties, the workflow generator 304 generates a visual representation of the weld instructions using the values that are defined for the weld instruction and/or using the determined default values. For example, the workflow generator 304 may select a first weld instruction and determine that a first property of the weld instruction is specified. The workflow generator 304 may further determine that a second property of the weld instruction is not specified. Because the second property is not specified, the workflow generator 304 may determine whether the weld instruction, the slide, the slide master, the part, and/or the root or global level have default values specified for the second property.

In some examples, where there are multiple, conflicting default values, the default value may be selected using the lowest level for which the default value is defined (e.g., the weld instruction level being the lowest, the root level being the highest). Additionally or alternatively, the property and/or the weld instruction may be tied to a particular level, such that when changes are made to the property value at the selected level, the property value is changed for the weld instruction even though another default value may be specified at a lower level than the selected level.

The example design interface 302 and the example workflow generator 304 enable the operator to make changes that are broadly applicable, and which can be implemented in the weld program at the time of generation.

The interface 400 enables a user to change the default values for properties, which causes the workflow generator 304 to propagate the changes to the properties of weld instructions that are based on the default value.

To implement the default values, the workflow generator 304 may look up and configure the property values for each relevant element based on specified property values and/or default property values at the different levels. Additionally or alternatively, the workflow generator 304 stores the specified values, the default values that are configured for the different levels, and/or the relationships between the properties, the weld instructions and/or other elements, the slides, the slide masters, the parts, and the root level. When the weld program is executed (e.g., by the computing device 10), the computing device 10 accesses the specified properties, the default properties, and the relationships, and configures the properties at execution of the weld program.

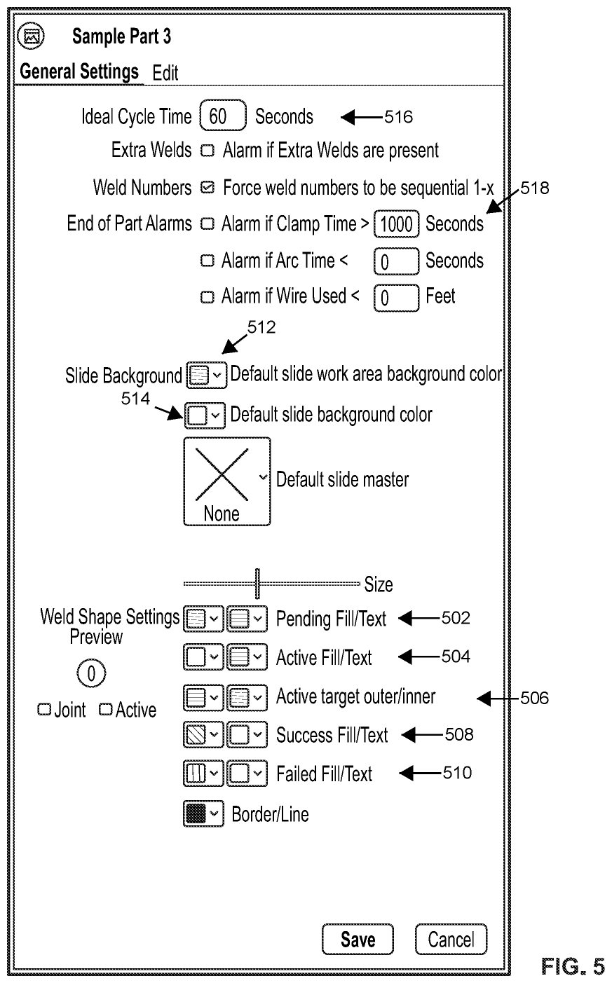

FIG. 5 illustrates an example part weld process properties interface 500 that may be used to implement the design interface 302. The example part weld process properties interface 500 of FIG. 5 includes default properties for a selected part weld process. For example, the default properties may be applied to each slide, event, component, and/or weld instruction created for the part unless overridden at the individual slide, slide master, event, component, and/or weld instruction levels. Example default properties include slide and/or component default colors, weld limits (e.g., number limits, weld count limits, etc.), part time limits, and/or any other properties.

As illustrated in FIG. 5, example visual properties include example properties may include colors (or other visual properties) associated with the status of the weld, such as fill and/or text colors for a pending weld instruction 502 (e.g., not yet active or completed), fill and/or text colors for an active weld instruction 504 (e.g., a weld instruction on which the operator is currently to be working), inner and/or outer colors for an active weld joint 506, fill and/or text colors for a successful weld instruction 508 (e.g., the weld instruction has been determined to be performed within specified parameters), and/or fill and/or text colors for a failed weld instruction 510 (e.g., the weld instruction has been determined not to be performed within specified parameters). The example interface 500 also enables a user to associate a slide master with slides generated for the part.

Other example properties illustrated in FIG. 5 for the part includes a default slide work area background color 512, a default slide background color 514, a target cycle time 516, and alarm values 518.

A rules engine 310 enforces aspects of a part weld process based on a set of custom and/or system-defined rules. Rules may involve visual display of slides, behavior of a part weld process, weld instruction management, and/or any other rules that may be defined. Rules are stored in a rules library 312, and may be global (e.g., applying to all parts), public (e.g., selectively applicable to parts), private (e.g., applicable to specific parts), and/or have any combination of global, public, and/or private characteristics.

During part weld process design using disclosed example systems (e.g., drag-and-drop operations) the rules engine 310 may maintain the visual look of the slide and the integrity. For example, a rule may be enforced that a slide can have only one instance of a defined weld at any given time. The rules engine 310 enforces the rule during drag and drop operations. Control modifiers such as keystrokes may be used to change design behavior when dragging and dropping components, such as using the “ctrl,” “shift,” and/or “alt” keys to modify the operation of the rules engine during the drag/drop operation.

Additionally or alternatively, the rules engine 310 may maintain a consistent visual appearance of objects in a slide by managing appearance configurations for components. For example, components added to a slide can have many different visual appearances (e.g., fill color, border color, size, etc.). The rules engine 310 may help the designer maintain a consistent appearance by storing and duplicating visual settings from previously-added components to newly-added components. Thus, the rules engine may reduce the configuration being done by the user, such as having to manually configure the appearance of each and every component added to the slide while maintaining the consistent component appearance.

In some examples, a designer may copy one or more components of one part weld process, and duplicate the components into one or more other part weld processes to save time. The example rules engine 310 maintains the configurations of the duplicated components from the part weld process that follows a set of rules both defined by Miller (as the creator of the application) and defined by the end user to meet their requirements. For example, the rules engine 310 may enforce a rule that a slide can have only one instance of a defined weld (e.g., only one “weld 1,” only one “weld 2,” etc.). During a copy/paste operation involving a numbered weld, the rules engine 310 may enforce the weld numbering by changing one or more conflicting weld numbers.

The example computing system 300 includes a gesture recognition engine 314 that recognizes gestures by a designer and takes actions based on the recognized gesture(s). The example gesture recognition engine 314 enables the designer to add various weld symbols and/or other elements to their slides using a touch screen and/or gestures. As used herein, the term “gesture” refers to one or more freehand strokes with an input device that are interpreted to take an action. For example, the gesture recognition engine 314 may recognize a gesture (e.g., via touchscreen, mouse, etc.) and perform the associated action. Gesture characteristics (e.g., the features used to recognize a gesture) and gesture responses (e.g., actions taken in response to a gesture) are stored in a gesture library 316 and accessed by the gesture recognition engine 314 for gesture recognition and/or response. When the gesture is recognized, the computing system 300 takes one or more actions corresponding to the identified gesture.

Example gestures may involve freehand drawings of simple shapes that are interpreted to insert a corresponding component or take a specific action. For example, a designer draws a crude weld symbol on the slide. In response, the gesture recognition engine 314 places a weld symbol of the type matching the drawn symbol and automatically number the weld. The designer may further enhance the weld symbol with borders, fills, text in the center, and/or other modifications.

Recognition of gestures and/or reaction to gestures may occur immediately and/or as a batch. The use of gestures may be more natural to some designers. Using gestures, a designer can draw the slide freehand, and the gesture recognition engine 314 converts the drawn elements to corresponding objects, symbols, and/or properties, corresponding to the locations in which the elements are drawn. Gestures may be used to specify values for properties of objects and/or specify a default level to which a property, weld instruction, slide, part, and/or other object is to be referenced to determine a value. Thus, disclosed examples improve the ease and speed with which part weld process design is accomplished.

In some examples, the designer can create and store custom gestures in the gesture library 316. The designer may apply the custom gestures to desired commands, such as frequently used commands and/or shapes used by the designer during part weld process design.

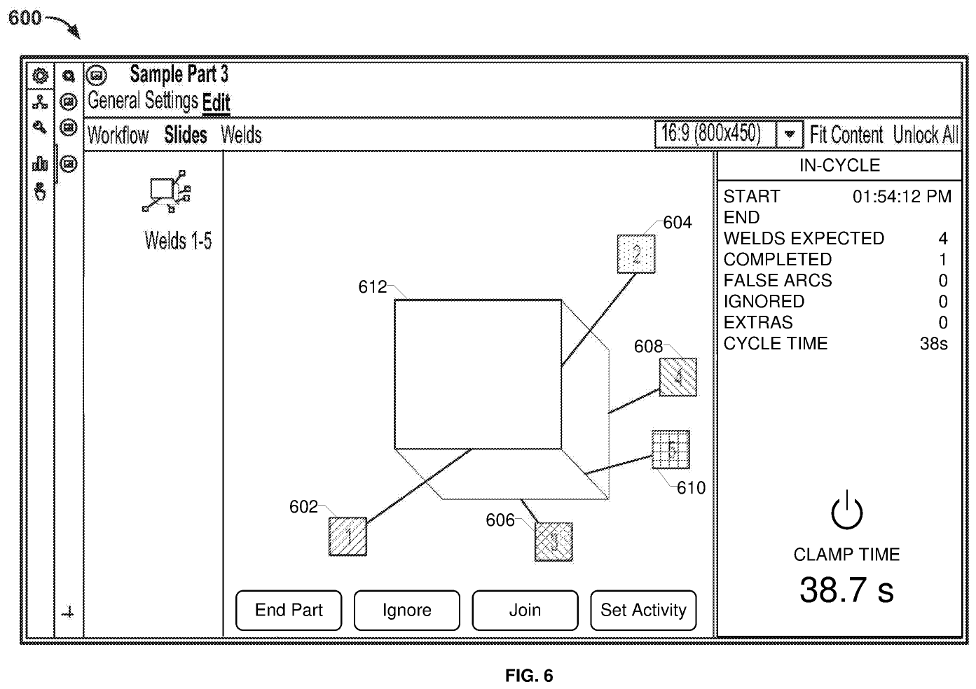

FIG. 6 illustrates an example interface 600 displaying weld instructions 602-610 of a weld program as presented on the example computing device 10 of FIG. 1, in which properties of the weld instructions 602-610 are controlled based on default values for the weld program. The example weld instructions 602-610 correspond to welds to be performed on a part 612 defined in the weld program. Each of the example weld instructions 602-610 is performed in order, and the computing device 10 and/or a monitoring device (e.g., the central computing system 46 of FIG. 1) monitor the welds to determine a status of part manufacturing.

As illustrated in FIG. 6, the weld instructions 602-610 are represented by indicators, which have visual properties that may be set or defined based on a status of the respective weld defined by the weld instruction. As illustrated in FIG. 5, example properties may include colors (or other visual properties) associated with the status of the weld, such as a pending weld instruction (e.g., not yet active or completed), an active weld instruction (e.g., a weld instruction on which the operator is currently to be working), a successful weld instruction (e.g., the weld instruction has been determined to be performed within specified parameters), and/or a failed weld instruction (e.g., the weld instruction has been determined not to be performed within specified parameters).

To determine the values of the properties, the computing device 10 parses the weld program to identify the weld instructions, slides, slide masters, parts, and/or other objects defining the weld program. At initial runtime and/or when specific weld instructions are to be presented to the weld operator, the computing system accesses the specified properties for the weld instructions, and determines the applicable default values to be applied to the properties of the weld instructions (e.g., at the appropriate levels for which default values are defined) for which values are not specified. Based on the specified and determined values, the computing device 10 presents the weld instructions to the weld operator as the weld operator progresses through the weld program.

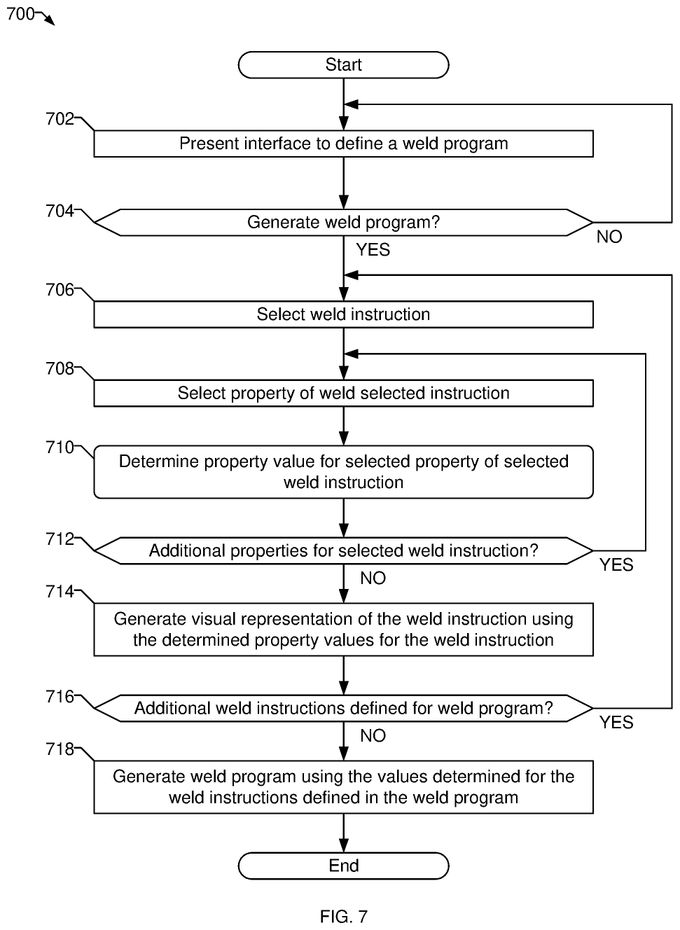

FIG. 7 is a flowchart representative of example machine readable instructions 700 which may be executed to generate weld instructions and/or other aspects of a part weld process. The example instructions 700 may be performed by the example computing system 46, the computing system 200 and/or the computing system 300 of FIGS. 1, 2, and/or 3. The example instructions 700 are described below with reference to the computing system 300, which may be implemented by the processor 202 executing the instructions 204 of FIG. 2.

At block 702, the processor 202 presents an interface to define a weld program. For example, the processor 202 may present the design interface 400 of FIG. 4 to enable a user to define a part, define weld instructions, specify property values and/or default property values, and/or associate parts, weld instructions, and/or properties with levels.

At block 704, the processor 202 determines whether a weld program is to be generated. For example, the processor 202 may generate a weld program based on weld instructions and/or other data defined via the interface 400, such as when the user saves changes to the weld program or manually triggers packaging of parts and/or weld instructions as a weld program. If the weld program is not to be generated (block 704), the processor 202 may iterate to block 702 to continue presenting the interface 400.

When the weld program is to be generated (block 704), at block 706 the processor 202 selects a weld instruction (e.g., a weld instruction defined in the interface). Selecting the weld instruction may involve determining a part, a slide, and/or other data with which the selected weld instruction has been associated. At block 708, the processor 202 selects a property of the selected weld instruction. For example, if the weld instructions are defined using XML, JSON, or other markup or data language, the processor 202 may the property from a list of tags or other representation of the properties associated with the weld instruction as the processor 202 iterates the property value determinations for the list of properties.

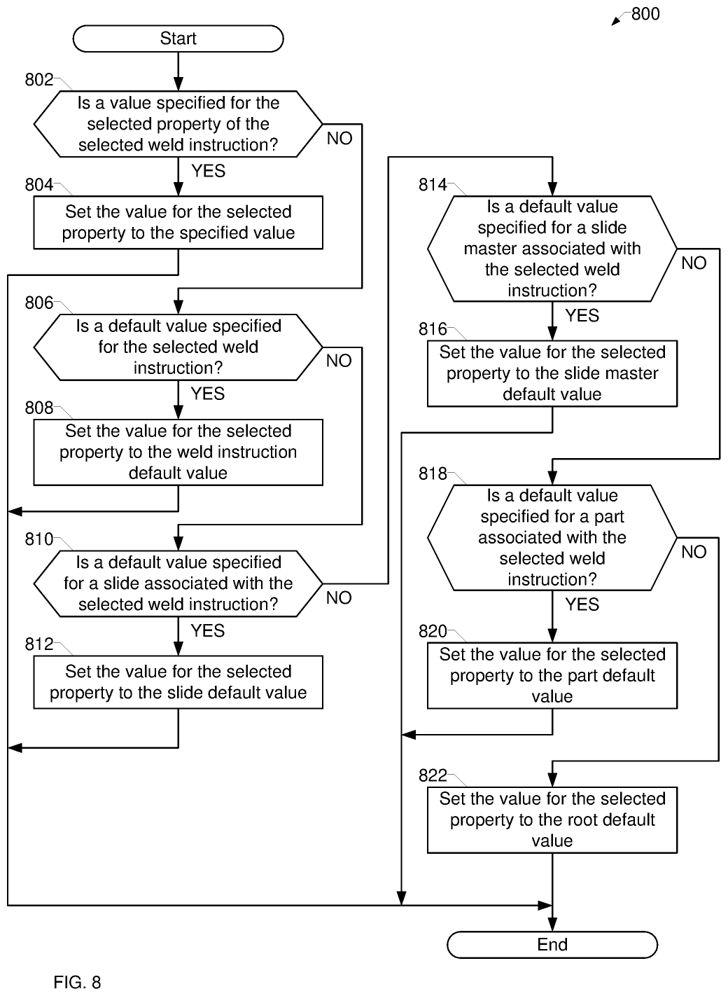

At block 710, the processor 202 determines a property value for the selected property of the selected weld instruction. For example, the processor 202 may determine whether the value has been specified for that property, or whether a default value should be used from one of multiple hierarchical levels. In some examples, a particular value or a lack of a value may indicate that a default value should be used for the property. In other examples, a related variable may indicate whether the property should inherit a value and/or which of multiple hierarchical levels should be the source of the inherited value. Example instructions to implement block 710 are disclosed below with reference to FIG. 8.

At block 712, the processor 202 determines whether there are additional properties for the selected weld instruction. For example, the processor 202 may determine whether additional XML property tags or fields are present for the selected weld instruction. If there are additional properties (block 712), control returns to block 708 to select a next property.

When there are no more properties (block 712), at block 714 the processor 202 generates a visual representation of the weld instruction using the determined property values for the weld instruction. For example, the processor 202 may create a visualization of the weld instruction, and store the visualization in the weld program and/or in association with the weld program for subsequent use. In some other examples, the weld instruction may be subsequently visualized (e.g., by the computing device 10 in a welding cell 16) using the property data (e.g., without a pre-rendered visualization).

At block 716, the processor 202 determines whether there are additional weld instructions defined for the weld program. If there are additional weld instructions (block 716), control returns to block 706 to select another weld instruction.

When there are no more weld instructions (block 716), the processor 202 generates the weld program using the values determined for the weld instructions defined in the weld program. For example, the processor 202 may store a weld program file containing the parts, slides, weld instructions, properties, and/or any other data that may be subsequently used by the computing device 10 to present the weld program to a weld operator and/or monitor welding of associated parts. The example instructions 700 then end.

FIG. 8 is a flowchart representative of example machine readable instructions 800 which may be executed to determine values for properties of a weld instruction. The example instructions 800 may be performed by the example computing device 10, the example computing system 46, the computing system 200 and/or the computing system 300 of FIGS. 1, 2, and/or 3. The example instructions 800 are described below with reference to the computing system 300, which may be implemented by the processor 202 executing the instructions 204 of FIG. 2.

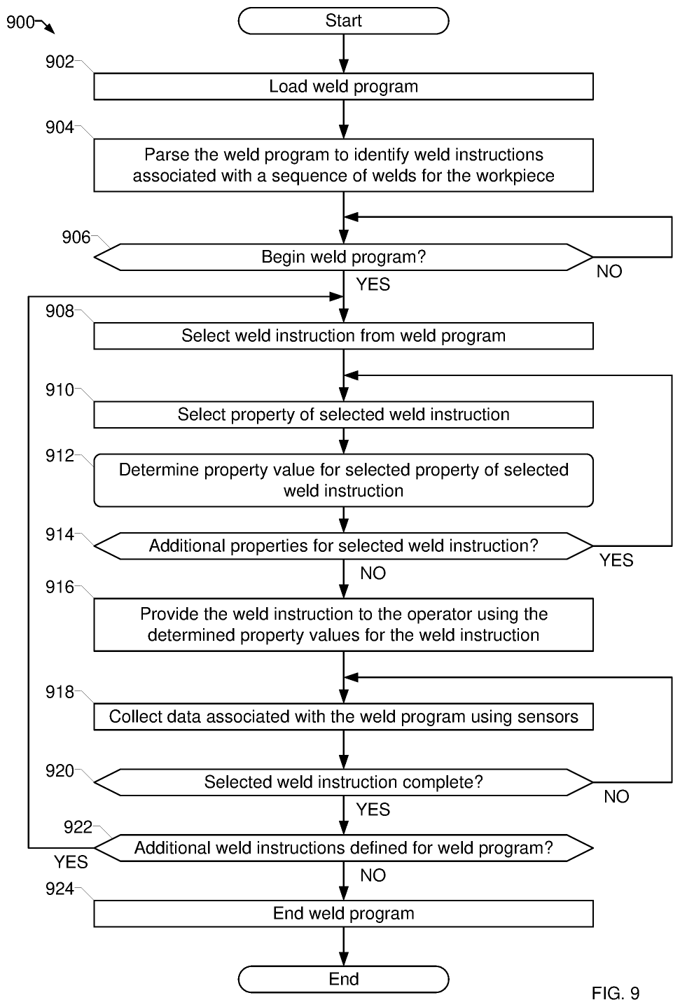

The example instructions 800 may be executed to implement block 710 of FIG. 7 and/or block 912 of FIG. 9, and begin with a selected weld instruction and a selected property (e.g., from block 706, 708 of FIG. 7). While the example instructions 800 are described with reference to weld instructions, the instructions 800 may be performed for events and/or other elements for which properties can be defined in a weld program.

At block 802, the processor 202 determines whether a value is specified for the selected property of the selected weld instruction and/or whether a related variable may indicate whether the property should inherit a value and/or which of multiple hierarchical levels should be the source of the inherited value. For example, a value may be specified as part by a user and stored in association with the property in a markup file or in a design interface. If the value is specified for the selected property of the selected weld instruction (block 802), at block 804 the processor 202 sets the value for the selected property to the specified value. For example, if the value is specified in the design interface 302, the processor 202 may store the value in a weld program file or a configuration file. An example configuration file may be stored locally with the weld program file, and/or may be remote from the computing device 10 executing the weld program, such as being located at a user-supplied device, on a remote server, a reference to a cascading style sheet or other data file, and/or any other type of configuration file.

Conversely, if the value is specified in the weld program file, the processor 202 may implement the value in the weld instruction.

If the value is not specified for the selected property of the selected weld instruction (block 802), at block 806 the processor 202 determines whether a default value is specified for the selected weld instruction. For example, the weld instruction may have a default value specified for one or more properties (e.g., inherited from previous instances of the same weld instruction). If the default value is specified for the selected weld instruction (block 806), at block 808 the processor 202 sets the value for the selected property to the specified value.

If the value is not specified for the selected weld instruction (block 806), at block 810 the processor 202 determines whether a default value is specified for a slide associated with the selected weld instruction. For example, the slide on which the weld instruction is located may have a default value specified for one or more properties. If the default value is specified for the slide (block 810), at block 812 the processor 202 sets the value for the selected property to the specified value for the slide.

If the value is not specified for the slide (block 810), at block 814 the processor 202 determines whether a default value is specified for a slide master associated with the selected weld instruction. For example, the slide master from which the slide on which the weld instruction is positioned may have a default value specified for one or more properties. If the default value is specified for the slide master (block 814), at block 816 the processor 202 sets the value for the selected property to the specified value for the slide master.

If the value is not specified for the slide master (block 814), at block 818 the processor 202 determines whether a default value is specified for a part associated with the selected weld instruction. For example, the part for which the weld instruction is defind may have a default value specified for one or more properties. If the default value is specified for the part (block 818), at block 820 the processor 202 sets the value for the selected property to the specified value for the part.

If the value is not specified for the slide master (block 818), at block 822 the processor 202 sets the value for the selected property to a root default value. For example, a root (or global) level may have default values set for properties. After setting the value for the selected property (block 804, block 808, block 812, block 816, block 820, or block 822), the example instructions end and return control to a calling function (e.g., block 710 of FIG. 7, block 912 of FIG. 9).

While the example instructions 800 cause the processor 202 to search multiple levels for a default value until the default value is found, in other examples the processor 202 determines which of the multiple levels is to be referenced to determine the default value for the property (e.g., without searching the levels). In some such examples, every level is provided with a default value for relevant properties, and the property is provided with additional data (or metadata) indicating which of the levels is to be referenced.

FIG. 9 is a flowchart representative of example machine readable instructions 900 which may be executed to present weld instructions to an operator based on a weld program. The example instructions 900 may be performed by the example computing device 10 and/or the computing system 200 of FIGS. 1 and/or 2. The example instructions 900 are described below with reference to the computing device 10.

At block 902, the computing device 10 loads a weld program, containing one or more slides and one or more weld instructions. At block 904, the computing device 10 parses the weld program to identify weld instructions associated with a sequence of welds. For example, the computing device 10 may identify the weld instructions and properties of the weld instructions.

At block 906, the computing device 10 determines whether the weld program is to be started. For example, the weld operator may select to begin the weld program via a user interface, and/or perform an action or trigger an event (e.g., clamping the part) resulting in initiation of the selected weld program. If the weld program is not starting (block 906), control iterates block 906 to wait for the weld program to begin.

When the weld program begins (block 906), at block 908 the computing device 10 selects a weld instruction from the weld program (e.g., identified from parsing in block 904). At block 910, the computing device 10 selects a property of the selected weld instruction (e.g., identified from parsing in block 904).

At block 912, the computing device 10 determines a property value for the selected property of the selected weld instruction. For example, the computing device 10 may determine whether the value has been specified for that property, or whether a default value should be used from one of multiple hierarchical levels. Example instructions to implement block 912 are disclosed above with reference to FIG. 8.

At block 914, the computing device 10 determines whether additional properties are identified for the selected weld instruction (e.g., for which property values are to be determined). If there are additional properties (block 914), control returns to block 910 to select another property.

When there are no more properties for the selected weld instruction (block 914), at block 916 the computing device 10 provides the weld instruction to the operator using the determined property values for the weld instruction. For example, the computing device 10 may display the weld instruction with determined visual properties, event information, and/or any other property information.

In some examples, the computing device 10 displays multiple weld instructions at a same time (e.g., on the same slide). In such examples, the computing device 10 may iterate determining the property values at blocks 910-914 for additional weld instructions, slide properties, part properties, and/or other elements of the weld program prior to providing the weld instructions, slides, parts, and/or other elements to the user (e.g., visually or otherwise).

At block 918, the computing device 10 collects data associated with the weld program using sensors. For example, the computing device 10 may collect the data via the weld data collection device 50 of FIG. 1 and one or more of the sensors 18-24. The computing device 10 may collect the data for the duration of the weld instruction (e.g., until the weld instruction is considered to be completed). At block 920, the computing device 10 determines whether the selected weld instruction is completed. If the weld instruction is not completed (block 920), control returns to block 918 to continue collecting the data.

When the weld instruction is completed (block 920), at block 922 the computing device 10 determines whether there are additional weld instructions defined for the weld program (e.g., determined at block 904 by parsing the weld program). If there are additional weld instructions (block 922), control returns to block 908 to select another weld instruction.

When there are no more weld instructions (block 922), at block 924 the computing device 10 ends the weld program, and the instructions 900 end. In other examples, the weld program may be restarted for another instance of the selected weld program, such as when a series of similar or identical parts are to be created using the weld program.

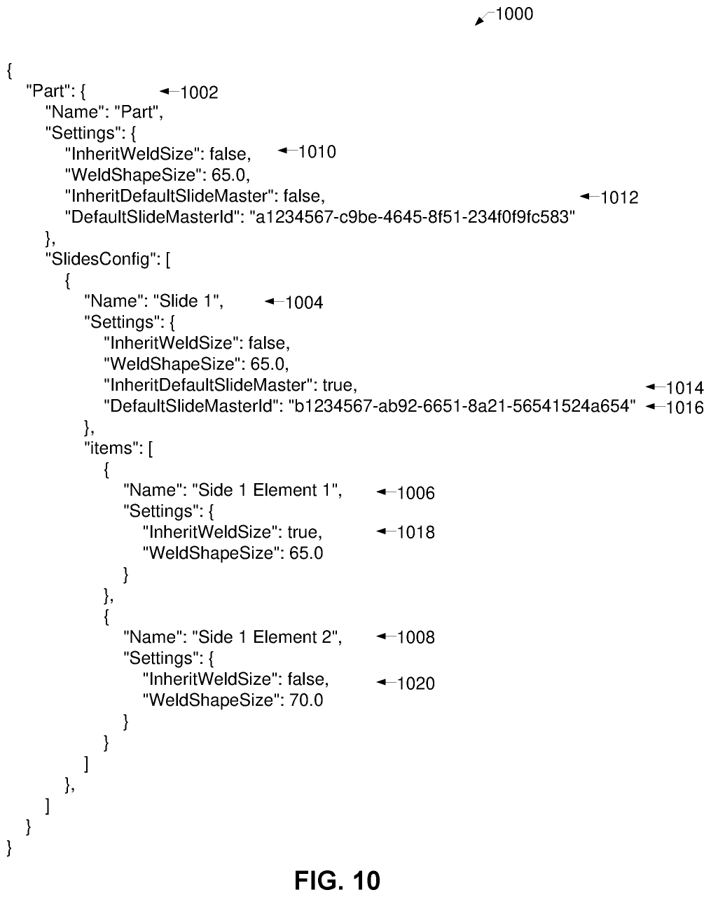

FIG. 10 illustrates example weld instruction data 1000 and/or metadata that may be used to define properties of weld instructions for creation and/or presentation of weld programs. The example data 1000 defines an example part 1002, an example slide 1004, and example elements 1006, 1008 (e.g., weld instructions) defined on the slide 1004.

The example part 1002 includes a data element 1010 that indicates whether the size of a weld is to be inherited from another level. As illustrated in FIG. 10, the value of the data element 1010 is “false,” which indicates that the size of the weld is specified rather than inherited. Conversely, the part 1002 includes a data element 1012 that indicates whether a properties of slides for the part should inherit values from a slide master, for which the value is also “false.”

The example slide 1004 has a data element 1014 that indicates that properties of the slide element may be inherited from a slide master, and the identifier of the slide master from which the properties should be inherited is provided by data element 1016.

The example elements 1006, 1008 include properties related to the sizes of the welds 1006, 1008 (e.g., when displayed to and/or performed by the operator). The example element 1006 includes a data element 1018 that indicates that the weld size should be inherited, while the element 1008 includes a data element 1020 that indicates that the weld size of the element 1008 should not be inherited.

During operation using a part weld process (e.g., using the computing device 10 of FIG. 1 to display weld instructions to the weld operator), events may be triggered by inputs to the computing device 10 and/or events internally identified by the computing device 10. Example inputs to the computing device 10 may include weld-related devices (e.g., data from a welding power supply, torch trigger, wire feeder, etc.), data from weld cell sensors (e.g., the sensors 18-24), weld monitoring devices (e.g., the weld data collection device 50 of FIG. 1), and/or an external computing system (e.g., the computing system 46 of FIG. 1). Additionally or alternatively, logic-driven or rule-driven events may be generated by the computing device 10 by combining inputs and/or data. Like the weld instructions discussed above, the events may have properties that are defined for individual instances and/or may inherit values from one or more levels of the weld program.

In some examples, an event may be triggered by a supervisor. For example, a shop or floor supervisor (or other authorized person) may instigate events in the welding cell as desired, such as a supervisor requesting an activity identification. The supervisor may be limited to triggering specific events, or may be permitted to trigger any available event.

In some examples, two or more events may be used to create a combined event that is triggered according to a logical condition. For example, the events may use logical conjunctions, disjunctions, mutual exclusion, and/or any other logic to define an event using other events. An example combined event may be “Event A AND (Event B or Event C).” Additionally or alternatively, logical events may be defined using logical flows (e.g., branching) with multiple individual events and multiple possible results from the logical event. Following different sequences of individual event triggers in a logical event results in different potential weld instructions. Weld instructions may be provided at the conclusion of a logical path of events and/or within a path of events (e.g., after execution of an event while waiting for the next event branch).

Similarly to logical events, in some examples, events are dependent on both the occurrence of the triggering input and one or more other conditions or stimuli. For example, conditional events based on input stimuli from the welding cell and its context may require a non-event condition to be present or not-present when a specified event occurs to be triggered. Conditional events may be used in conjunction with combined events and/or logical events.

An example instruction that may improve clarity for weld operators during a welding operation involves changing a zoom level of the display. For example, instructions may include zooming to a weld (e.g., changing a zoom level to focus on a particular weld, zooming to a particular area of a slide based on location of a particular specified weld), zooming to an area (e.g., zooming to a particular specified area of a slide), zooming to a slide boundary (e.g., zooming to a particular specified area of a slide, including snapping to a boundary of the slide), zooming to fit an entire slide, zooming to fit any selected component, zooming to fit contents (e.g., zooming so as to include all the specified contents or components, such a group of selected components or all components belonging to a part or shape), and/or enabling the weld operator to specify the zooming. In some examples, time-adjacent zooming actions involve panning and/or changing a zoom level directly from a first zoom to a second zoom. Alternatively, time-adjacent zooming actions involve zooming out from the first zoom level before zooming into the second zoom level, which can help orient the welder to the portion of the slide in the second zoom level and reduce mistakes. Zooming may be used as a property that can be inherited by weld instructions, slides, parts, and/or any other elements.

The example design interface 302 of FIG. 3 may be used to create slide masters. In some examples, the design interface 302 uses slide masters as backgrounds that can be designed and reused on individual slides. The design interface 302 enables creation of slide masters similarly way to creating a slide.

Slide masters may be provided a name or other identifier, and a visual thumb is created to represent the slide master. During the part design process, the designer can select a slide master to be used for creating slides. When a slide master is chosen for one or more slides, the slide(s) display the slide master under other added elements. Changes to slide masters are propagated through to each slide referencing the slide master. In some examples, the slide master is used as a background image behind the components on a slide. A thumbnail image may be used to represent slide masters for selection.

In some other examples, the slide master is used as a starting slide. Instances of every component on the slide master are created and populated onto each slide. During the design of the slide, the instances of each component generated based on the slide master may be manipulated in a manner similar or identical to components introduced to the specific slide. Default property values may be assigned to a slide master, which can then be inherited by properties of weld instructions, parts, slides, and/or any other elements associated with the slide master.

The example design interface 302 enables creation and manipulation of shapes. In some examples, the design interface 302 enables shapes to be designed like slides. Visual representations of items are dragged and/or otherwise added to the slide canvas and/or arranged by the designer. When the desired shape and/or set of visual objects are arranged and configured, the designer can save the arrangement as a new shape using the component manager 306. The newly defined shape is stored in the component library 308 and can be used in other slides, slide masters, and/or designing additional custom shapes. The designer is able to reuse the shapes on many slides, thereby saving the designer time. If the shape is modified at a later time, the user may choose to apply changes to the shape to one or more (e.g., all) of the places where the shape is used. In some examples, changes to the shape in the component library 308 causes the component manager 306 to automatically update all instances of the shape in all slides and/or slide masters.

An operation interface control may be added to slides or other weld operator interface components using the design interface 302. Operation interface controls are shown to a weld operator during normal weld process steps, and may be displayed independently of the slides and/or other part weld process information. Operation interface controls enable organizations to display organization-specific custom information to weld operators. The operation interface control may be a configurable dashboard screen that permits a designer to specify the information shown to weld operators, the format in which the information is shown, and/or the locations in which the information is seen on the display. Such operator interface controls are elements for which properties can be defined and/or determined using default values.

The present methods and systems may be realized in hardware, software, and/or a combination of hardware and software. The present methods and/or systems may be realized in a centralized fashion in at least one computing system, or in a distributed fashion where different elements are spread across several interconnected computing systems. Any kind of computing system or other apparatus adapted for carrying out the methods described herein is suited. A typical combination of hardware and software may include a general-purpose computing system with a program or other code that, when being loaded and executed, controls the computing system such that it carries out the methods described herein. Another typical implementation may comprise an application specific integrated circuit or chip. Some implementations may comprise a non-transitory machine-readable (e.g., computer readable) medium (e.g., FLASH drive, optical disk, magnetic storage disk, or the like) having stored thereon one or more lines of code executable by a machine, thereby causing the machine to perform processes as described herein. As used herein, the term “non-transitory machine-readable medium” is defined to include all types of machine readable storage media and to exclude propagating signals.

As utilized herein the terms “circuits” and “circuitry” refer to physical electronic components (i.e. hardware) and any software and/or firmware (“code”) which may configure the hardware, be executed by the hardware, and or otherwise be associated with the hardware. As used herein, for example, a particular processor and memory may comprise a first “circuit” when executing a first one or more lines of code and may comprise a second “circuit” when executing a second one or more lines of code. As utilized herein, “and/or” means any one or more of the items in the list joined by “and/or”. As an example, “x and/or y” means any element of the three-element set {(x), (y), (x, y)}. In other words, “x and/or y” means “one or both of x and y”. As another example, “x, y, and/or z” means any element of the seven-element set {(x), (y), (z), (x, y), (x, z), (y, z), (x, y, z)}. In other words, “x, y and/or z” means “one or more of x, y and z”. As utilized herein, the term “exemplary” means serving as a non-limiting example, instance, or illustration. As utilized herein, the terms “e.g.,” and “for example” set off lists of one or more non-limiting examples, instances, or illustrations. As utilized herein, circuitry is “operable” to perform a function whenever the circuitry comprises the necessary hardware and code (if any is necessary) to perform the function, regardless of whether performance of the function is disabled or not enabled (e.g., by a user-configurable setting, factory trim, etc.).

While the present methods and/or systems have been described with reference to certain implementations, it will be understood by those skilled in the art that various changes may be made and equivalents may be substituted without departing from the scope of the present method and/or system. For example, block and/or components of disclosed examples may be combined, divided, re-arranged, and/or otherwise modified. In addition, many modifications may be made to adapt a particular situation or material to the teachings of the present disclosure without departing from its scope. Therefore, the present method and/or system are not limited to the particular implementations disclosed. Instead, the present method and/or system will include all implementations falling within the scope of the appended claims, both literally and under the doctrine of equivalents.

What is claimed is:

1. A system to generate weld instructions for display to a weld operator during a welding sequence, the system comprising:
a processor; and
a machine readable storage device comprising machine readable instructions which, when executed by the processor, cause the processor to:
provide an interface to define a weld program comprising a sequence of weld instructions for display to a weld operator during a weld sequence, the weld program comprising a plurality of properties;
determine, for each of the weld instructions in the sequence of weld instructions, respective values for one or more of the properties that are defined via the interface; and
generate the weld program comprising the sequence of weld instructions by, for each of the weld instructions in the sequence of weld instructions:
determining, for one or more of the properties that have not been defined for the weld instruction, default values for the properties; and
generating a visual representation of the weld instruction using the values that are defined for the weld instruction and using the determined default values.

2. The system as defined in claim 1, wherein the machine readable instructions cause the processor to, for each of the weld instructions in the sequence of weld instructions:
determine one or more hierarchical levels corresponding to the default values; and
determine the default values based on values set at the corresponding hierarchical levels.

3. The system as defined in claim 2, wherein the machine readable instructions cause the processor to:
identify a change in at least one of the default values used by the sequence of weld instructions; and
update the weld program based on the change.

4. The system as defined in claim 2, wherein the hierarchical levels comprise at least one of:
a root level, the processor configured to use a value for one of the properties defined at the root value as a default value for any slide;
a part level defined for a part, the processor configured to use a value for one of the properties defined at the part level as a default value for any slide associated with the part;
a slide master level, the processor configured to use a value for one of the properties defined at the slide master level as a default value for any slide associated with the slide master;
a slide level, the processor configured to use a value for one of the properties defined at the slide level as a default value for any weld instructions associated with the slide; or
a weld instruction level, the processor configured to use a value for one of the properties defined at the weld instruction level as a default value for any weld associated with the weld instruction.

5. The system as defined in claim 2, wherein the machine readable instructions cause the processor to:
identify a change in one of the properties from the corresponding default value to a defined value; and
update the weld program based on the change.

6. The system as defined in claim 1, wherein the one or more properties comprise at least one of: an operator shift time, a welding parameter threshold, a welding productivity goal, an operator authorization, an operator interface configuration, or a workflow event configuration.

7. The system as defined in claim 1, wherein the one or more properties comprise a pointer to a configuration file representative of a plurality of the one or more properties.

8. The system as defined in claim 1, wherein the one or more properties comprise at least one of: an object color, a text color, a background color, a text typeface, a text font, or a background image.

9. The system as defined in claim 1, wherein the weld program defines an event and a response to the event, wherein the processor is configured to generate the weld program by:
determining, for one or more of the properties for the event, default values for the properties; and
in response to an event trigger, performing the event based on the default values for the one or more properties of the event.

10. The system as defined in claim 1, wherein the instructions cause the processor to generate the visual representation of the weld instruction by generating metadata associated with the weld instruction based on the values that are defined for the weld instruction and the determined default values.

11. A system for monitoring welding of components of a workpiece with multiple arc welds in a fixture, the system comprising:
a computing device storing a weld program defining weld instructions for performing the multiple arc welds, the computing device configured to:
parse the weld program to identify weld instructions associated with a sequence of welds for the workpiece;
determine, for a first one of the weld instructions, whether a first property of the first one of the weld instructions has a defined value;
in response to determining that the first property does not have a defined value, determine a default value for the first property; and
provide the first one of the weld instructions to a weld operator based on the default value of the first property.

12. The system as defined in claim 11, wherein the computing device is configured to:
determine, for a second one of the weld instructions, whether a second property of the second one of the weld instructions has a defined value; and
in response to determining that the second property has a defined value, provide the second one of the weld instructions to a weld operator based on the defined value of the second property.

13. The system as defined in claim 11, further comprising one or more weld sensors configured to collect data associated with the multiple arc welds, wherein the computing device is configured to determine statuses of the multiple arc welds based on the data.

14. The system as defined in claim 11, wherein the computing device is configured to determine the default value from at least one of:
a root level for one of the visual properties defined at the root value as a default value for any slide;
a part level defined for a part for one of the visual properties defined at the part level as a default value for any slide associated with the part;
a slide master level for one of the visual properties defined at the slide master level as a default value for any slide associated with the slide master;
a slide level for one of the visual properties defined at the slide level as a default value for any weld instructions associated with the slide; or
a weld instruction level for one of the visual properties defined at the weld instruction level as a default value for any weld associated with the weld instruction.

15. The system as defined in claim 11, wherein the first property comprises at least one of: an operator shift time, a welding parameter threshold, a welding productivity goal, an operator authorization, an operator interface configuration, or a workflow event configuration.

16. The system as defined in claim 11, wherein the first property comprises a pointer to a configuration file representative of a plurality of the one or more properties.

17. The system as defined in claim 11, wherein the first property comprises at least one of: an object color, a text color, a background color, a text typeface, a text font, or a background image.
